(19) United States
(12) Patent Application Publication
(10) Pub. No.: US 2026/0094019 A1
(43) Pub. Date: Apr. 2, 2026

(54) DEVICE, DATA STRUCTURE AND COMPUTER IMPLEMENTED METHOD FOR DETERMINING A KNOWLEDGE GRAPH IN PARTICULAR FOR PERFORMING KNOWLEDGE GRAPH REASONING

(71) Applicant: Robert Bosch GmbH, Stuttgart (DE)

(72) Inventors: Evgeny Kharlamov, Muenchen (DE); Antonios Klironomos, Mannheim (DE); Heiko Paulheim, Mannheim (DE)

(21) Appl. No.: 19/332,384

(22) Filed: Sep. 18, 2025

(30) Foreign Application Priority Data
Oct. 1, 2024 (DE) 10 2024 209 616.4

(51) Int. Cl. G06N 5/022; G06N 5/04

(52) U.S. Cl. CPC G06N 5/022; G06N 5/04

(57) ABSTRACT

A device, a data structure, and a computer implemented method for determining a knowledge graph for performing knowledge graph reasoning. The method includes providing, in an embedding space, a set of entities, a set of relations, and a set of attributes; providing a first set of triples, each respective triple includes a head entity from the set of entities, a relation from the set of relations, and a tail entity from the set of entities; and providing a second set of triples, each respective triple includes an entity from the set of entities, an attribute from the set of attributes, and a literal value. The method includes determining for the entities from the set of entities an association that includes for a respective entity from the set of entities the literal values from the triples of the second set of triples that include the respective entity.

### CROSS REFERENCE

The present application claims the benefit under 35 U.S.C. § 119 of Germany Patent Application No. DE 10 2024 209 616.4 filed on Oct. 1, 2024, which is expressly incorporated herein by reference in its entirety.

### FIELD

The present invention relates to a device, a data structure and a computer implemented method for determining a knowledge graph in particular for performing knowledge graph reasoning.

### SUMMARY

The computer implemented method and the device according to the present invention provide a relation-centric enhancement to knowledge graph reasoning.

According to an example embodiment of the present invention, the method for determining a knowledge graph in particular for performing knowledge graph reasoning, comprises providing, in an embedding space, a set of entities, a set of relations, and a set of attributes, providing a first set of triples, wherein a respective triple of the first set comprises a head entity from the set of entities, a relation from the set of relations, and a tail entity from the set of entities, providing a second set of triples, wherein a respective triple of the second set comprises an entity from the set of entities, an attribute from the set of attributes, and a literal value, wherein the method comprises determining for the entities from the set of entities an association that comprises for a respective entity from the set of entities the literal values from the triples of the second set of triples that comprise the respective entity, determining, for the respective relations from the set of relations a respective first aggregation of the literal values depending on the literal values that are associated in the association with an entity that at least one of the triples of the first set of triples comprising the respective relation comprises as the head entity, determining, for the respective relations from the set of relations a respective second aggregation of the literal values depending on the literal values that are associated in the association with an entity that at least one of the triples of the first set of triples comprising the respective relation comprises as the tail entity, determining a replacement for the respective relation in the embedding space depending on the respective relation and the first aggregation determined for the respective relation and the second aggregation determined for the respective relation, and replacing the respective relation in the triples of the first set of triples with the replacement determined for the respective relation

This means, the method infuses numeric information from literal values into the embeddings of connecting relations of the knowledge graph. The literal values of the attributes are aggregated separately for the relation's domain generating two distinct numeric aggregations, the first aggregation and the second aggregation. The aggregated numeric information is then combined with the relation embedding to form the replacement of the relation. Such infusion enriches the relation embeddings with information about possible correlations between the attributes.

According to an example embodiment of the present invention, the method may comprise determining a matrix defining the association, wherein the matrix comprises entries, wherein the entry for a respective entity of the set of entities and a respective attribute of the set of attributes contains the literal value of the attribute for the respective entity if the second set of triples comprises a triple with the respective entity and the respective attribute or else indicates, in particular with a value of Zero, that the second set of triples comprises no triple with the respective entity and the respective attribute.

According to an example embodiment of the present invention, the method may comprise determining for the respective relation a first vector defining the first aggregation of the literal values, wherein the first vector comprises an aggregation of the entries of the rows of the matrix that the matrix comprises for the entities that at least one of the triples of the first set of triples comprising the respective relation comprises as the head entity, and determining for the respective relation a second vector defining the second aggregation of the literal values, wherein the second vector comprises an aggregation of the entries of the rows of the matrix that the matrix comprises for the entities that at least one of the triples of the first set of triples comprising the respective relation comprises as the tail entity.

Several ways of aggregation may be used. The method, for example, comprises determining the aggregation of the literal values comprises determining a mean, a median, a mode, a minimum, a maximum, a sum, a count, a range, an interquartile range, a variance, or a standard deviation of the distribution of the literal values of the same column of the row vectors.

According to an example embodiment of the present invention, the aggregation may be based on a linear combination of different ways of aggregation. Determining the aggregation of the literal values for example comprises determining a linear combination of at least two of the mean, the median, the mode, the minimum, the maximum, the sum, the count, the range, the interquartile range, the variance, or the standard deviation of the distribution of the literal values.

The linear combination may be treated as a hyperparameter for machine learning. The method for example comprises learning at least one parameter defining the linear combination depending on training data comprising the first set of triples and the second set of triples.

According to an example embodiment of the present invention, the method may comprise performing knowledge graph reasoning on the triples of the first set of triples comprising the replacement to predict a plausibility of a triple that comprises a given head entity, a given tail entity and a given relation corresponding to the replacement exists. The replacement embeddings comprise information about possible correlations between the attributes. This means, the reasoning on triples comprising the replacement embeddings is enhanced by the information about the possible correlations between the attributes.

The knowledge graph may be tailored for use in a production environment. An example for the production environment is a production line, in particular for welding, for example automotive welding. For example, the set of entities comprises entities that represent a sensor of a production line, respectively, and entities that represent a workstation of the production line, respectively, wherein the set of relations comprises a relation indicating that a workstation represented by an entity that is linked with an entity representing a sensor by the relation has the sensor, wherein the method comprises providing a set of literal values indicating a range, wherein the set of attributes comprises an attribute indicating that a sensor represented by an entity that is linked by the attribute to a literal value of the set of literal values has the range indicated by the literal value. For automotive welding, a link prediction task in the knowledge graph reasoning may involve finding which sensor, in particular which sensor providing the measurement of a welding spot, belongs to which workstation, in particular which car body that is welded in the workstation. In this context, there is a large amount of numeric data from sensors measuring different physical quantities. The sensors may have different ranges, i.e. measuring ranges. The attributes and the literal values representing the ranges are linked to the entities representing the sensors. Thus, the knowledge graph leverages these ranges to increase the accuracy of link prediction.

The knowledge graph may be tailored for use in other environments as well. For example, the set of entities comprises entities that represent a person respectively and entities that represent a house respectively, wherein the set of relations comprises a relation indicating that a person represented by an entity linked with an entity representing a house by the relation rents the house, wherein the method comprises providing a first set of literal values indicating a monthly rent, wherein the set of attributes comprises a first attribute indicating that a house represented by an entity linked by the first attribute to a first literal value of the first set of literal values costs the monthly rent indicated by the first literal value and/or wherein the method comprises providing a second set of literal values indicating a monthly income, wherein the set of attributes comprises a second attribute indicating that a person represented by an entity linked by the second attribute to a second literal value of the second set of literal values costs the monthly rent indicated by the second literal value.

According to an example embodiment of the present invention, the device for determining a knowledge graph in particular for performing knowledge graph reasoning comprises at least one processor, and at least one memory, wherein the at least one memory stores instructions that, when executed by the at least one processor, cause the device to execute the method of the present invention.

A computer program may be provided, wherein the computer program comprises computer-readable instructions that, when executed by the computer, cause the computer to execute the method of the present invention.

According to an example embodiment of the present invention, a data structure may be provided, wherein in that the data structure comprises at least one data field for embeddings in an embedding space of a set of entities, a set of relations, and a set of attributes, at least one set of literal values, a first set of triples, wherein a respective triple of the first set comprises a head entity from the set of entities, a relation from the set of relations, and a tail entity from the set of entities, a second set of triples, wherein a respective triple of the second set comprises an entity from the set of entities, an attribute from the set of attributes, and a literal value, an association, determined for the entities from the set of entities, that comprises for a respective entity from the set of entities the literal values from the triples of the second set of triples that comprise the respective entity, for the respective relations from the set of relations a respective first aggregation of the literal values determined depending on the literal values that are associated in the association with an entity that at least one of the triples of the first set of triples comprising the respective relation comprises as the head entity, for the respective relations from the set of relations a respective second aggregation of the literal values determined depending on the literal values that are associated in the association with an entity that at least one of the triples of the first set of triples comprising the respective relation comprises as the tail entity, a replacement for the respective relation in the embedding space determined depending on the respective relation and the first aggregation (lh) determined for the respective relation and the second aggregation (lt) determined for the respective relation.

Further examples of the present invention are derived from the following description and the figures.

### BRIEF DESCRIPTION OF THE DRAWINGS

FIG. 1 schematically depicts a device for determining a knowledge graph in particular for performing knowledge graph reasoning, according to an example embodiment of the present invention.

FIG. 2 shows a flow chart comprising steps of a method for determining a knowledge graph in particular for performing knowledge graph reasoning, according to an example embodiment of the present invention.

FIG. 3 schematically depicts a data structure, according to an example embodiment of the present invention.

### DETAILED DESCRIPTION OF EXAMPLE EMBODIMENTS

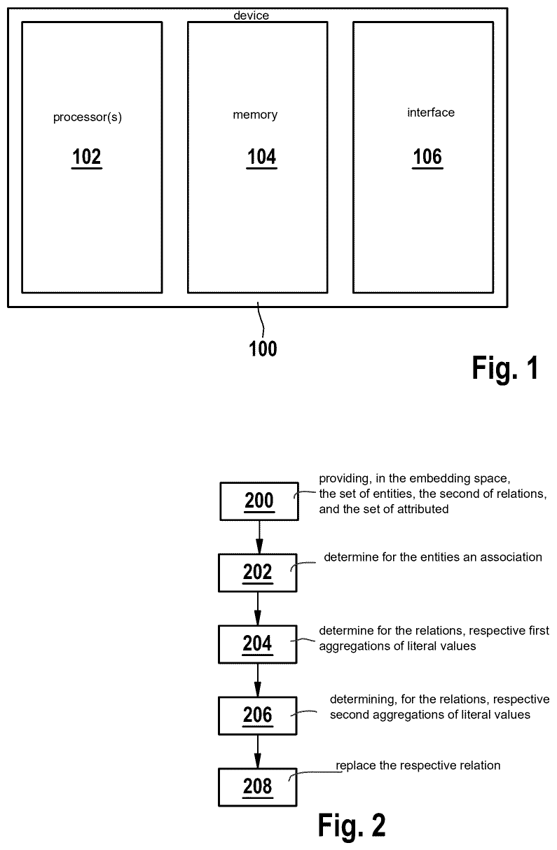

FIG. 1 schematically depicts a device 100 for determining a knowledge graph.

The device 100 may be configured for performing knowledge graph reasoning.

The device 100 comprises at least one processor 102 and at least one memory 104.

The device 100 may comprise at least on interface 106.

The at least one memory 104 stores instructions that, when executed by the at least one processor 102, cause the device 100 to execute a method for determining the knowledge graph in particular for performing knowledge graph reasoning.

The knowledge graph is based on a set E of entities e, a set R of relations r, a set A of attributes, in an embedding space of the knowledge graph, and a set V of literal values.

The knowledge graph comprises a first set of triples. A respective triple of the first set comprises a head entity h from the set E of entities, a relation r from the set R of relations, and a tail entity e from the set E of entities.

The knowledge graph comprises a second set of triples. A respective triple of the second set comprises an entity e from the set E of entities, an attribute a from the set A of attributes, and a literal value v from the set V of literal values.

According to a first example, the set E of entities comprises entities e that represent a sensor of a production line respectively and entities e that represent a workstation of the production line respectively.

According to the first example, the set R of relations comprises a relation r indicating that a workstation represented by an entity that is linked with an entity representing a sensor by the relation r has the sensor.

According to the first example, the set V of literal values indicate a range.

According to the first example, the set of attributes A comprises an attribute a indicating that a sensor represented by an entity e that is linked by the attribute a to a literal value v of the set V of literal values has the range indicated by the literal value v.

According to a second example, the set E of entities comprises entities e that represent a person respectively and entities e that represent a house respectively.

According to the second example, the set of relations R comprises a relation r indicating that a person represented by an entity linked with an entity representing a house by the relation r rents the house.

According to the second example, two sets V of literal values are provided:

A first set V1 of literal values indicating a monthly rent and a second set V2 of literal values indicating a monthly income.

According to the second example the set of attributes A comprises a first attribute a1 indicating that a house represented by an entity linked by the first attribute a1 to a first literal value v1 of the first set V1 of literal values costs the monthly rent indicated by the first literal value v1.

According to the second example the set of attributes A comprises a second attribute a2 indicating that a person represented by an entity linked by the second attribute a2 to a second literal value v2 of the second set V2 of literal values costs the monthly rent indicated by the second literal value v2.

FIG. 2 depicts a flow chart comprising steps of the method.

The method comprises a step 200.

The step 200 comprises providing, in the embedding space:
the set E of entities e
the set R of relations r,
the set A of attributes a.

The step 200 comprises providing the first set of triples and the second set of triples.

The method comprises a step 202.

The step 202 comprises determining for the entities e from the set E of entities an association L that comprises for a respective entity e from the set E of entities the literal values v from the triples of the second set of triples that comprise the respective entity e.

The association L may be defined by a matrix L∈ [symbol] .

The method may comprise determining the matrix L defining the association L.

The matrix is for example determined to comprise entries Lᵢₖ. The entry Lᵢₖ for an entity eᵢ and an attribute aₖ is for example determined to comprise the literal value v of the attribute aₖ for the entity eᵢ if the second set of triples comprises a tripel with the entity eᵢ and the attribute aₖ or else indicates, in particular with a value of Zero, that the second set of triples comprises no triple with the entity eᵢ and the attribute aₖ.

This means, the entry Lᵢₖ for a respective entity eᵢ of the set E of entities and a respective attribute aₖ of the set of attributes A contains the literal value v of the attribute aₖ for the respective entity eᵢ if the second set of triples comprises a triple with the respective entity eᵢ and the respective attribute aₖ or else indicates, in particular with a value of Zero, that the second set of triples comprises no triple with the respective entity eᵢ and the respective attribute aₖ.

The method comprises a step 204.

The step 204 comprises determining, for the respective relations r from the set R of relations a respective first aggregation lh of the literal values depending on the literal values v that are associated in the association L with an entity e that at least one of the triples of the first set of triples comprising the respective relation comprises as the head entity h.

The step 204 comprises determining, for the respective relations r from the set R of relations a respective second aggregation lt of the literal values depending on the literal values v that are associated in the association L with an entity e that at least one of the triples of the first set of triples comprising the respective relation r comprises as the tail entity t.

The aggregations may be vectors of the same dimension as the relations have in the embedding space.

Determining the first aggregation may comprise determining for the respective relation r a first vector lₕ∈ [symbol] defining the first aggregation lh of the literal values.

The first vector lₕ comprises for example an aggregation of the entries of the rows of the matrix L that the matrix L comprises for the entities e that at least one of the triples of the first set of triples comprising the respective relation comprises as the head entity h.

Determining the second aggregation may comprise determining for the respective relation r a second vector lₜ∈ [symbol] defining the second aggregation lt of the literal values.

The second vector lₜ comprises for example an aggregation of the entries of the rows of the matrix L that the matrix L comprises for the entities e that at least one of the triples of the first set of triples comprising the respective relation comprises as the tail entity t.

The first vector lₕ or the second vector lₜ may be determined as a row vector.

Determining the respective aggregation of the literal values may comprise determining a mean of the literal values of the same column of the row vectors as the aggregation value in the respective column of the first vector lₕ or the second vector lₜ.

Determining the respective aggregation of the literal values may comprise determining a median of the literal values of the same column of the row vectors as the aggregation value in the respective column of the first vector lₕ or the second vector lₜ.

Determining the respective aggregation of the literal values may comprise determining a mode of the literal values of the same column of the row vectors as the aggregation value in the respective column of the first vector lₕ or the second vector lₜ.

Determining the respective aggregation of the literal values may comprise determining a minimum of the literal values of the same column of the row vectors as the aggregation value in the respective column of the first vector lₕ or the second vector lₜ.

Determining the respective aggregation of the literal values may comprise determining a maximum of the literal values of the same column of the row vectors as the aggregation value in the respective column of the first vector lₕ or the second vector lₜ.

Determining the respective aggregation of the literal values may comprise determining a sum of the literal values of the same column of the row vectors as the aggregation value in the respective column of the first vector lₕ or the second vector lₜ.

Determining the respective aggregation of the literal values may comprise determining a count of the literal values of the same column of the row vectors as the aggregation value in the respective column of the first vector lₕ or the second vector lₜ.

Determining the respective aggregation of the literal values may comprise determining a range of the literal values of the same column of the row vectors as the aggregation value, e.g., a two-dimensional aggregation value comprising the two borders of the range, in the respective column of the first vector lₕ or the second vector lₜ.

Determining the respective aggregation of the literal values may comprise determining an interquartile range of the literal values of the same column of the row vectors as the aggregation value in the respective column of the first vector lₕ or the second vector lₜ.

Determining the respective aggregation of the literal values may comprise determining a variance of the literal values of the same column of the row vectors as the aggregation value in the respective column of the first vector lₕ or the second vector lₜ.

Determining the respective aggregation of the literal values may comprise determining a standard deviation of the distribution of the literal values of the same column of the row vectors as the aggregation value in the respective column of the first vector lₕ or the second vector lₜ.

Determining the aggregation of the literal values may comprise determining a linear combination of at least two of the mean, the median, the mode, the minimum, the maximum, the sum, the count, the range, the interquartile range, the variance, or the standard deviation of the distribution of the literal values.

The linear combination may be defined as

$$y = σ ( U {W}_{a} + {b}_{1} ) )$$

wherein y| [symbol] , wherein U∈ [symbol] comprises rows u that comprise a respective aggregation function of the i considered ways of aggregations, e.g. at least two of the mean, the median, the mode, the minimum, the maximum, the sum, the count, the range, the interquartile range, the variance, or the standard deviation of the distribution of the literal values, wherein Wₐ∈ [symbol] comprises learnable parameters, wherein b₁∈ [symbol] is an optional learnable parameter, and σ is the sigmoid function.

An example for a row u and an aggregation function ⊕Φ for N attributes is

$$u = ( {⊕}_{i = 1}^{\vert E \vert} Φ ( {L}_{i 1} ) … {⊕}_{i = 1}^{\vert E \vert} Φ ( {L}_{iN} ) )$$

The method may comprise learning at least one parameter defining the linear combination, e.g., Wₐ and/or b₁ depending on training data comprising the first set of triples and the second set of triples.

The method comprises a step 206.

The step 206 comprises determining a replacement for the respective relation r in the embedding space depending on the respective relation r and the first aggregation lh determined for the respective relation r and the second aggregation lt determined for the respective relation r.

For example, the replacement rᵣ∈ [symbol] for the respective relation r∈ [symbol] is determined as

$${r}_{r} = {g}_{l i n} ( {l}_{h} , r , {l}_{t} )$$

wherein Dr is the dimension of the embedding space.

The function gₗᵢₙ may be defined as

$${g}_{l i n} = {W}_{r}^{T} [ {l}_{h} , r , {l}_{t} ] + {b}_{2}$$

wherein Wᵣ∈ [symbol] comprises at least one learnable parameter, and b₂∈ [symbol] is an optional learnable parameter. The method may comprise learning at least one parameter defining the function gₗᵢₙ, e.g., Wᵣ and/or b₂ depending on training data comprising the first set of triples and the second set of triples.

The replacement may be determined in with a gated function

$${g}_{gated} = z ⊙ h + ( 1 - z ) ⊙ r$$

wherein ⊙ denotes an element-wise multiplication, and

$$z = σ ( {W}_{z l h}^{T} {l}_{h} + {W}_{z r}^{T} r + {W}_{zlt}^{T} {l}_{t} + {b}_{3} )$$

$$h = {h}^{′} ( {W}_{r}^{T} [ {l}_{h} , r , {l}_{t} ]$$

wherein W_{zr}∈ [symbol] , W_{zlh}∈ [symbol] , W_{zlt}∈ [symbol] , b₃∈ [symbol] , h′ is a nonlinear function, e.g., tanh, applied elementwise, and σ is the sigmoid function.

For example, the replacement rᵣ∈ [symbol] for the respective relation r∈ [symbol] is determined as

$${r}_{r} = {g}_{gatetd} ( {l}_{h} , r , {l}_{t} )$$

The method may comprise learning at least one parameter defining the function g_{gated}, e.g., W_{zr}, W_{zlh}, W_{zlt} and/or b₃ depending on training data comprising the first set of triples and the second set of triples.

The learning may comprise learning the parameters that lead to a replacement of the relations from the set of relations R that improves the link prediction quality with respect to the link prediction quality that is achieved with the triples of the knowledge graph comprising the relation from the set of relations R.

The method comprises a step 208.

The step 208 comprises replacing the respective relation r in the triples of the first set of triples with the replacement rₗᵢₜ determined for the respective relation r.

The output of the function gₗᵢₙ or the function g_{gatetd} is a vector of the same dimension as the relation r.

The resulting vector from the function gₗᵢₙ or the function g_{gatetd} is a literal-enhanced embedding vector, capable of substituting the original embedding vector of the relation r within a scoring function for link prediction.

For example the relation rᵢ, i.e., the respective embedding vector, is replaced with r_{r,i}, in particular r_{r,i}=gₗᵢₙ(lₕ, rᵢ, lₜ) or r_{r,i}=g_{gated}(lₕ, rᵢ, lₜ).

The method may comprise a step 210.

The step 210 comprises performing knowledge graph reasoning on the triples of the first set of triples comprising the replacement to predict a plausibility of a triple that comprises a given head entity, a given tail entity and a given relation corresponding to the replacement exists.

According to the first example, a presence of a welding spot on a car body that is present in a workstation be detected when a link between an entity that represents a sensor providing the measurement of the welding spot and an entity that represents the workstation in which the car body is present is predicted with the knowledge graph reasoning on the triples of the first set of triples comprising the replacement determined for the first set of triples according to the first example.

According to the second example, a person renting a house is determined when a link between an entity that represents the person and an entity that represents the house is predicted with the knowledge graph reasoning on the triples of the first set of triples comprising the replacement determined for the first set of triples according to the second example.

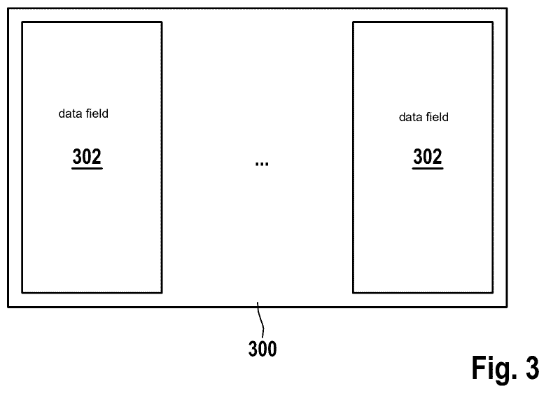

FIG. 3 schematically depicts a data structure 300.

The data structure 300 comprises at least one data field 302 for embeddings in the embedding space of the set of entities, the set of relations, the set of attributes, at least one set of literal values.

The data structure 300 comprises at least one data field 302 for the first set of triples, and the second set of triples.

The data structure 300 comprises at least one data field 302 for the association.

The data structure 300 comprises at least one data field 302 for the respective first aggregation and the respective second aggregation

The data structure 300 comprises at least one data field 302 for the replacement for the respective relation in the embedding space.

What is claimed is:

1. A computer implemented method for determining a knowledge graph for performing knowledge graph reasoning, the method comprising the following steps:
providing, in an embedding space, a set of entities, a set of relations, and a set of attributes;
providing a first set of triples, wherein each respective triple of the first set of triples includes a head entity from the set of entities, a relation from the set of relations, and a tail entity from the set of entities;
providing a second set of triples, wherein each respective triple of the second set includes an entity from the set of entities, an attribute from the set of attributes, and a literal value;
determining, for the entities from the set of entities, an association that includes, for each respective entity from the set of entities, the literal values from the triples of the second set of triples that include the respective entity;
determining, for the respective relations from the set of relations, a respective first aggregation of the literal values depending on the literal values that are associated, in the association, with an entity that at least one of the triples of the first set of triples includes the respective relation includes as the head entity;
determining, for the respective relations from the set of relations, a respective second aggregation of the literal values depending on the literal values that are associated, in the association, with an entity that at least one of the triples of the first set of triples including the respective relation includes as the tail entity;
determining a replacement for the respective relation in the embedding space depending on the respective relation and the first aggregation determined for the respective relation and the second aggregation determined for the respective relation; and
replacing the respective relation in the triples of the first set of triples with the replacement determined for the respective relation.

2. The method according to claim 1, further comprising:
determining a matrix defining the association, wherein the matrix includes entries, wherein an entry for a respective entity of the set of entities and a respective attribute of the set of attributes contains the literal value of the attribute for the respective entity when the second set of triples includes a triple with the respective entity and the respective attribute or else indicates, with a value of Zero, that the second set of triples includes no triple with the respective entity and the respective attribute.

3. The method according to claim 2, further comprising:
determining, for the respective relation, a first vector defining the first aggregation of the literal values, wherein the first vector includes an aggregation of the entries of rows of the matrix that the matrix includes for the entities that at least one of the triples of the first set of triples including the respective relation includes as the head entity; and
determining for the respective relation a second vector defining the second aggregation of the literal values, wherein the second vector includes an aggregation of the entries of rows of the matrix that the matrix includes for the entities that at least one of the triples of the first set of triples including the respective relation includes as the tail entity.

4. The method according to claim 3, wherein the determining of the the aggregation of the literal values includes determining a mean, or a median, or a mode, or a minimum, or a maximum, or a sum, or a count, or a range, or an interquartile range, or a variance, or a standard deviation, of the distribution of the literal values of a same column of the vectors.

5. The method according to claim 4, wherein the determining of the aggregation of the literal values includes determining a linear combination of at least two of the mean, the median, the mode, the minimum, the maximum, the sum, the count, the range, the interquartile range, the variance, or the standard deviation, of the distribution of the literal values.

6. The method according to claim 3, further comprising:
learning at least one parameter defining the linear combination depending on training data including the first set of triples and the second set of triples.

7. The method according to claim 1, further comprising:
performing knowledge graph reasoning on the triples of the first set of triples including the replacement to predict a plausibility of a triple that includes a given head entity, a given tail entity, and a given relation corresponding to the replacement exists.

8. The method according to claim 1, wherein the set of entities includes entities that represent a sensor of a production line respectively and entities that represent a workstation of the production line respectively, wherein the set of relations includes a relation indicating that a workstation represented by an entity that is linked with an entity representing a sensor by the relation has the sensor, and wherein the method comprises providing a set of literal values indicating a range, wherein the set of attributes includes an attribute indicating that a sensor represented by an entity that is linked by the attribute to a literal value of the set of literal values has the range indicated by the literal value.

9. The method according to claim 1, wherein the set of entities includes entities that represent a person respectively and entities that represent a house respectively, wherein the set of relations includes a relation indicating that a person represented by an entity linked with an entity representing a house by the relation rents the house, wherein the method comprises: (i) providing a first set of literal values indicating a monthly rent, wherein the set of attributes includes a first attribute indicating that a house represented by an entity linked by the first attribute to a first literal value of the first set of literal values costs the monthly rent indicated by the first literal value, and/or (ii) providing a second set of literal values indicating a monthly income, wherein the set of attributes includes a second attribute indicating that a person represented by an entity linked by the second attribute to a second literal value of the second set of literal values costs the monthly rent indicated by the second literal value.

10. A device for determining a knowledge graph for performing knowledge graph reasoning, the device comprising:
at least one processor; and
at least one memory, wherein the at least one memory stores instructions that, when executed by the at least one processor, cause the device to execute a method for comprising the following steps:
providing, in an embedding space, a set of entities, a set of relations, and a set of attributes,
providing a first set of triples, wherein each respective triple of the first set of triples includes a head entity from the set of entities, a relation from the set of relations, and a tail entity from the set of entities,
providing a second set of triples, wherein each respective triple of the second set includes an entity from the set of entities, an attribute from the set of attributes, and a literal value,
determining, for the entities from the set of entities, an association that includes, for each respective entity from the set of entities, the literal values from the triples of the second set of triples that include the respective entity,
determining, for the respective relations from the set of relations, a respective first aggregation of the literal values depending on the literal values that are associated, in the association, with an entity that at least one of the triples of the first set of triples includes the respective relation includes as the head entity,
determining, for the respective relations from the set of relations, a respective second aggregation of the literal values depending on the literal values that are associated, in the association, with an entity that at least one of the triples of the first set of triples including the respective relation includes as the tail entity,
determining a replacement for the respective relation in the embedding space depending on the respective relation and the first aggregation determined for the respective relation and the second aggregation determined for the respective relation, and
replacing the respective relation in the triples of the first set of triples with the replacement determined for the respective relation.

11. A non-transitory computer readable medium on which is stored a computer program including computer-readable instructions for determining a knowledge graph for performing knowledge graph reasoning, the instructions, when executed by a computer, causing the computer to perform the following steps:
providing, in an embedding space, a set of entities, a set of relations, and a set of attributes;
providing a first set of triples, wherein each respective triple of the first set of triples includes a head entity from the set of entities, a relation from the set of relations, and a tail entity from the set of entities;
providing a second set of triples, wherein each respective triple of the second set includes an entity from the set of entities, an attribute from the set of attributes, and a literal value;
determining, for the entities from the set of entities, an association that includes, for each respective entity from the set of entities, the literal values from the triples of the second set of triples that include the respective entity;
determining, for the respective relations from the set of relations, a respective first aggregation of the literal values depending on the literal values that are associated, in the association, with an entity that at least one of the triples of the first set of triples includes the respective relation includes as the head entity;
determining, for the respective relations from the set of relations, a respective second aggregation of the literal values depending on the literal values that are associated, in the association, with an entity that at least one of the triples of the first set of triples including the respective relation includes as the tail entity;
determining a replacement for the respective relation in the embedding space depending on the respective relation and the first aggregation determined for the respective relation and the second aggregation determined for the respective relation; and
replacing the respective relation in the triples of the first set of triples with the replacement determined for the respective relation.

12. A data structure, comprising:
at least one data field for embeddings in an embedding space of a set of entities, a set of relations, and a set of attributes, at least one set of literal values, a first set of triples, wherein each respective triple of the first set includes a head entity from the set of entities, a relation from the set of relations, and a tail entity from the set of entities, a second set of triples, wherein each respective triple of the second set includes an entity from the set of entities, an attribute from the set of attributes, and a literal value, an association, determined for the entities from the set of entities, that includes for each respective entity from the set of entities the literal values from the triples of the second set of triples that include the respective entity, for the respective relations from the set of relations a respective first aggregation of the literal values determined depending on the literal values that are associated in the association with an entity that at least one of the triples of the first set of triples including the respective relation includes as the head entity, for the respective relations from the set of relations a respective second aggregation of the literal values determined depending on the literal values that are associated in the association with an entity that at least one of the triples of the first set of triples including the respective relation includes as the tail entity, a replacement for the respective relation in the embedding space determined depending on the respective relation and the first aggregation determined for the respective relation and the second aggregation determined for the respective relation.
